(19) United States
(12) Patent Application Publication
(10) Pub. No.: US 2025/0374385 A1
(43) Pub. Date: Dec. 4, 2025

(54) COOKING APPLIANCE WITH DIGITAL CONTROLLER DOOR AND METHOD FOR CONTROLLING FAN OF DIGITAL CONTROLLER DOOR

(71) Applicant: LG Electronics Inc., Seoul (KR)

(72) Inventors: Dong Hun KIM, Seoul (KR); Young Jin KIM, Seoul (KR); Jeongkil KIM, Seoul (KR); Junhwan JANG, Seoul (KR); Geon KWON, Seoul (KR); Hansu LEE, Seoul (KR)

(73) Assignee: LG Electronics Inc., Seoul (KR)

(21) Appl. No.: 19/222,229

(22) Filed: May 29, 2025

(30) Foreign Application Priority Data
May 30, 2024 (KR) 10-2024-0070766
Dec. 16, 2024 (KR) 10-2024-0187292

(51) Int. Cl. H05B 6/64

(52) U.S. Cl. CPC H05B 6/642; H05B 6/6435

(57) ABSTRACT

A cooking appliance can include a main portion including a cavity for receiving food, and one or more functional components, the main portion being configured to provide a cooking function, a display door coupled to the main portion, the display door including a display configured to provide a user interface, and a door controller. Also, the door controller can set an operation level of a door fan of the display door based on state information of at least one of the one or more functional components of the main portion or state information of at least one component of the display door.

### CROSS-REFERENCE TO RELATED APPLICATION

This application claims priority to and the benefit of Korean Patent Application No. 10-2024-0070766, filed on May 30, 2024, and Korean Patent Application No. 10-2024-0187292, filed on Dec. 16, 2024, both in the Republic of Korea, the entireties of all these applications are incorporated herein by reference.

### BACKGROUND

### Field

The present disclosure relates to a cooking appliance including a digital controller door and a method for controlling a fan of the digital controller door.

### Description of Related Art

A cooking appliance is a home appliance that cooks food using microwaves belonging to electromagnetic waves and/or heater heat. The cooking appliance can be generally provided with a cavity as a space in which food is placed and cooked, and a door for opening and closing the cavity.

When the cooking appliance is installed indoors, it is desirable to consider efficient use of the cooking appliance, saving of an installation space thereof, etc.

For this reason, the cooking appliance can be disposed at a position adjacent to a heating cooking device, for example, a heating oven, a gas stove, etc. Specifically, the cooking appliance can be disposed on top of the heating cooking device.

When the cooking appliance is disposed on top of the heating cooking device, the user can conveniently cook food by reducing the movement of the user in an environment in which the cooking appliance and the heating cooking device are adjacent to each other. In addition, heat, oil vapor, etc. as generated from the heating cooking device can be discharged to the outside using the cooking appliance as a hood.

In a state in which the cooking appliance is disposed on top of the heating cooking device, heat, oil vapor, or the like generated from the heating cooking device disposed under the cooking appliance can adversely affect the operation of the cooking appliance.

For example, a display can be mounted on a front surface of a door provided in the cooking appliance and can be configured to provide various information to the user. The user can know a cooking state of the cooked food through the display.

In addition, when the display is connected to another home appliance so as to serve as a hub of the home appliances, information other than cooking food can be obtained through the display. In addition, the user can input a command for cooking and various other commands to the display in a touch manner.

In a state in which the cooking appliance is disposed on top of the heating cooking device, heat, oil vapor, etc. generated from the heating cooking device can invade into parts mounted on the display and the door.

It is desirable to suppress damage to or malfunction of the display of the cooking appliance and other components mounted on the door due to such heat, oil vapor, or the like.

The heat generated from the heating cooking device can rise under a convection to heat the display mounted on the cooking appliance, thereby causing the display to be damaged by the heat or causing a malfunction of the display.

Therefore, proper cooling is required so that the display does not become overheated. At least one fan device can be used to cool the display. However, when a large number of fan devices are used to cool the display or the fan device is rotated at an excessively high speed, noise of the fan device can make the user uncomfortable and excessive electricity can be consumed by the fan device.

A component for controlling the display and a component for controlling the operation of the cooking appliance operate in different operating manners. The component that controls the display can act as an information processing unit in that it interacts with the user. On the other hand, the cooking appliance can repeatedly perform a specific function.

Accordingly, a need exists for a scheme of defining a control of these two components or information flow manner therebetween and setting a process corresponding thereto so that the cooking appliance can be safely controlled in a normal operation and an abnormal operation situation is required. In particular, it is desirable to control the fan so that the digital controller door can operate safely even at high temperatures. Also, a need exists for a cooking appliance having a configuration that is capable of automatically and dynamically controlling a door fan in a display door of the cooking appliance to be set to different operating levels based on different conditions of components within a main portion of the cooking appliance and parts within the display door, in a manner that balances user convenience while also enhancing safety and increasing the lifespan of the cooking appliance.

### SUMMARY OF THE DISCLOSURE

Thus, the present disclosure has been devised to solve the above problem. A purpose of the present disclosure is to provide a technology for safe controlling of cooking appliances by allowing various software or hardware of doors combined with cooking appliances to operate smoothly with control components that control the cooking appliance.

Further, a purpose of the present disclosure is to provide a technology for a cooking appliance that performs a cooling algorithm in response to various heated situations occurring in the cooking appliance having door with control component.

Purposes according to the present disclosure are not limited to the above-mentioned purpose. Other purposes and advantages according to the present disclosure that are not mentioned can be understood based on following descriptions, and can be more clearly understood based on embodiments according to the present disclosure. Further, it will be understood that the purposes and advantages according to the present disclosure can be realized using means shown in the claims or combinations thereof.

A cooking appliance including a digital controller door according to an embodiment of the present disclosure includes a functional unit (e.g., main body or main portion of the cooking appliance) configured to provide a cooking function, in which a controller is configured to set an operation level of a door fan of the digital controller door based on state information of each of components of the function unit or the digital controller door.

A method for controlling a fan of a digital controller door of a cooking appliance according to an embodiment of the present disclosure is disclosed. The cooking appliance includes a functional unit configured to provide a cooking function, collecting, by a controller, state information of each of components of the functional unit or the digital controller door, and setting, by the controller, an operation level of a door fan of the digital controller door based on the collected state information.

In accordance with the present disclosure, the various software or hardware of the door coupled to the cooking appliance cooperates smoothly with the control component for controlling the cooking appliance, thereby safely controlling the cooking appliance and improving stability thereof.

Further, in accordance with the present disclosure, the control component of the door coupled to the cooking appliance performs a cooling algorithm in response to various heated situations occurring in the cooking appliance, thereby preventing the overheated state of the components.

The effects of the present disclosure are not limited to the above-described effects, and those skilled in the art can derive various effects of the present disclosure from the configuration of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 is a conceptual diagram of a cooking appliance including a digital controller door according to an embodiment of the present disclosure.

FIG. 2 is a diagram illustrating components of a digital controller door and components of a functional unit according to an embodiment of the present disclosure.

FIG. 3 is a diagram illustrating categories of functions performed by an OS controller and a function controller according to an embodiment of the present disclosure.

FIG. 4 is a perspective view illustrating a cooking appliance according to an embodiment of the present disclosure.

FIG. 5 is a diagram illustrating a state in which the digital controller door 100 (e.g., display door or smart door) is opened in FIG. 4 according to an embodiment of the present disclosure.

FIG. 6 is a perspective view illustrating a digital controller door (e.g., display door) of a cooking appliance according to an embodiment of the present disclosure.

FIG. 7 is a schematic view illustrating a position where a cooking appliance is disposed according to an embodiment of the present disclosure.

FIG. 8 is a diagram illustrating a process in which an operating system (OS) or controller controls an operating state of a door fan controller according to an embodiment of the present disclosure.

FIG. 9 is a diagram showing a table about factors according to an embodiment of the present disclosure.

FIG. 10 is a diagram illustrating a process of setting an operation level of a door fan based on each of factors according to an embodiment of the present disclosure.

FIG. 11 is a diagram showing a table about factors according to another embodiment of the present disclosure.

FIG. 12 is a diagram illustrating a process of setting an operation level of a door fan based on each of factors according to another embodiment of the present disclosure.

FIG. 13 is a diagram illustrating a process in which an OS controller (e.g., door controller) sets an operation level based on an operation time duration of each component or a timing at which an operation is to be terminated later according to an embodiment of the present disclosure.

FIG. 14 is a diagram illustrating a process in which an OS controller (e.g., door controller) changes an operation level of the door fan based on a cooking time duration according to an embodiment of the present disclosure.

FIG. 15 is a diagram illustrating a process in which an OS controller (e.g., door controller) changes the operation level of the door fan based on an operating time duration of a ventilation fan according to an embodiment of the present disclosure.

FIG. 16 is a diagram illustrating a process in which the OS controller (e.g., door controller) changes an operation level of a door fan in relation to an operation of a display according to an embodiment of the present disclosure.

FIG. 17 is a diagram illustrating a process in which an OS controller (e.g., door controller) sets an operation level of a door fan in an error occurrence situation according to an embodiment of the present disclosure.

FIG. 18 is a view illustrating a process in which an OS controller (e.g., door controller) sets an operation level of the door fan in an auto ventilation process according to an embodiment of the present disclosure.

### DETAILED DESCRIPTION OF THE EMBODIMENTS

Hereinafter, embodiments of the present disclosure will be described in detail with reference to the drawings so that those skilled in the art to which the present disclosure pertains can easily implement the present disclosure. The present disclosure can be implemented in several different forms and is not limited to the embodiments described herein.

In order to clearly describe the present disclosure, parts irrelevant to the description are omitted, and the same reference numerals refer to the same or similar components throughout the specification. Further, some embodiments of the present disclosure will be described in detail with reference to the example drawings. In adding reference numerals to the components of each drawing, the same components can be denoted by the same reference numerals as much as possible even though the components are shown in different drawings. In addition, in describing the present disclosure, when it is determined that a detailed description of related known components or functions can obscure the gist of the present disclosure, the detailed description thereof can be omitted.

It will be understood that, although the terms “first,” “second,” “third,” and so on can be used herein to describe various elements, components, areas, layers and/or units, these elements, components, areas, layers and/or units should not be limited by these terms. These terms are used to distinguish one element, component, area, layer or unit from another element, component, area, layer or unit. Thus, a first element, component, area, layer or unit as described under could be termed a second element, component, area, layer or unit, without departing from the spirit and scope of the present disclosure. It will be understood that when a first element or layer is referred to as being “connected to,” “jointed to” or “coupled to” a second element or layer, the first element can be directly connected to or jointed to or coupled to the second element or layer, or one or more intervening elements or layers can be present therebetween. In addition, it will also be understood that when an element or layer is referred to as being “between” two elements or layers, it can be the only element or layer between the two elements or layers, or one or more intervening elements or layers can also be present therebetween.

In addition, in the implementation of the present disclosure, the component can be subdivided for convenience of description. However, this component can be implemented in one device or module, or one component can be implemented so as to be distributed into a plurality of devices or modules.

The present disclosure relates to a technique for controlling a cooking appliance using a digital controller door disposed at a front surface of the cooking appliance.

According to the present disclosure, a door of a microwave oven disposed on an oven or a gas stove includes an LCD or OLED screen. An Android board of the LCD or OLED screen and a microcomputer of the microwave oven cooperate with each other. An LCD or OLED component operates according to various operating/external environments of the microwave oven or controls a specific function of the microwave oven.

The digital controller door of the present disclosure can be combined with the cooking appliance to open and close the inside of the cooking appliance. An embodiment of the cooking appliance of the present disclosure is a microwave oven. However, embodiments of the present disclosure is not limited thereto. An embodiment of the cooking appliance including the digital controller door of the present disclosure includes each of various cooking appliances which includes a door equipped with a display such as an LCD or OLED screen providing various user interfaces such as a touch screen, and is capable of storing and cooking food therein. And embodiments of the present disclosure is not limited to a specific display panel type. The features of various embodiments of the present disclosure can be partially or entirely coupled to or combined with each other and can be interlocked and operated in technically various ways, and the embodiments can be carried out independently of or in association with each other. Also, the term “can” used herein includes all meanings and definitions of the term “may.”

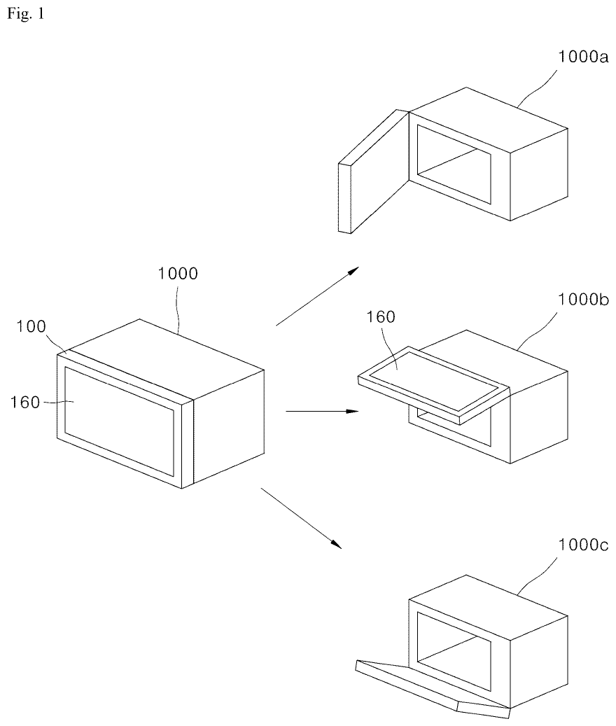

FIG. 1 is a conceptual diagram of a cooking appliance including a digital controller door according to an embodiment of the present disclosure.

The cooking appliance 1000 includes a digital controller door 100 at a front surface thereof. The digital controller door 100 includes one or two or more displays, and the display of the digital controller door 100 can display information about the inside of the cooking appliance 1000 or information related to an operation thereof to the user. The display of the digital controller door 100 can provide a touch input interface for receiving a predetermined command from the user.

A manner in which the digital controller door 100 is opened includes an embodiment 1000a, 1000b, or 1000c. 1000a shows an embodiment in which the digital controller door 100 pivots around a left side of the cooking appliance 1000a to open the right side of the cooking appliance 1000a, and open the inside of the cooking appliance 1000a. 1000b shows an embodiment in which the digital controller door 100 pivots around a top side of the cooking appliance 1000b to open the bottom side of the cooking appliance 100b, and open the inside of the cooking appliance 1000b. 1000c shows an embodiment in which the digital controller door 100 pivots around a bottom side of the cooking appliance 1000c to open the top side of the cooking appliance 1000c, and open the inside of the cooking appliance 1000c.

A display 160 can be mounted on the front surface of the digital controller door 100 to provide various information to a user. The user can know the cooking state of the cooked food on the display 160. The display 160 can be embodied as an LCD. However, embodiments of the present disclosure is not limited thereto, and the display 160 can include various display panels. In addition, a touch panel for touch input can be coupled to the display 160.

The digital controller door 100 controls the operation of the cooking appliance 1000 and outputs various information. The cooking appliance 1000 performs cooking using microwaves or heater heat. Accordingly, a digital controlling function provided by the digital controller door 100 and a cooking function of the cooking appliance 1000 are provided in different ways and in different areas.

The digital controller door 100 of the present disclosure can serve as a kind of a hub. That is, the digital controller door 100 can serve as a hub of another home appliance and display information transmitted from another home appliance on the display 160. In this process, the user can obtain other information other than the cooking food on the display 160. In addition, the user can input a command for cooking and various other commands to the display 160 in a touch manner.

To this end, in accordance with the present disclosure, a method and a configuration in which the digital controller door 100 and the cooking appliance 1000 respectively include independent control components, and these control components cooperate with each other to control the function of the cooking appliance will be described.

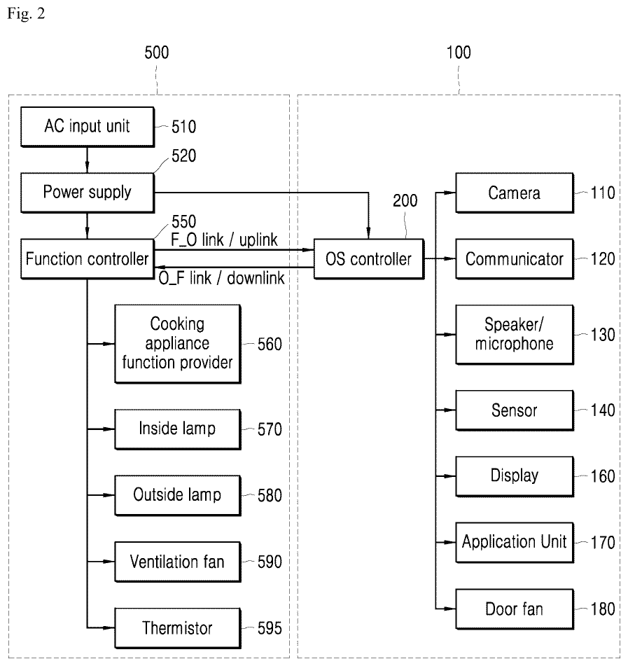

FIG. 2 is a diagram illustrating components of a digital controller door and components of a functional unit according to an embodiment of the present disclosure. Each of the components is conceptually disposed and is not limited to a specific physical location or material.

The digital controller door 100 (e.g., display door or smart display door, etc.) can operate as an Internet-of-things hub. The digital controller door 100 can include an OS controller 200 (e.g., door controller). In addition, the digital controller door 100 can include a camera 110. In addition, the digital controller door 100 can include a communicator 120. In addition, the digital controller door 100 can include a speaker/microphone 130. In addition, the digital controller door 100 can include a sensor 140. In addition, the digital controller door 100 can include the display 160. In addition, the digital controller door 100 can include an application unit 170. In addition, the digital controller door 100 can include a door fan 180. The door fan can be embodied as a direct current (DC) fan and cools the heat of the digital controller door 100. In particular, the door fan 180 cools heat generated from the display 160.

Hereinafter, the OS controller 200 (e.g., door controller), the camera 110, the communicator 120, the speaker/microphone 130, the sensor 140, the display 160, the application unit 170, and the door fan 180 are referred to as elements or components of the digital controller door 100 (e.g., display door).

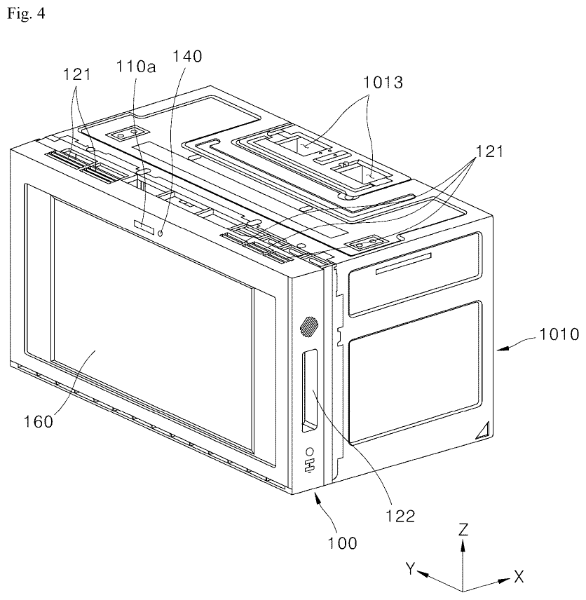

The functional unit 500 (e.g., main body or main portion) includes an AC input unit 510, a power supply 520, a function controller 550 (e.g., main controller or oven controller, etc.), a cooking appliance function provider 560 (e.g., magnetron, microwave generator, heater), an inside lamp 570, an outside lamp 580, a ventilation fan (vent fan) 590, etc. The functional unit 500 (e.g., main body) and the digital controller door 100 (e.g., smart door, or display door) are logically configured for the description of the present disclosure. The functional unit 500 (e.g., a main body or main portion of the cooking appliance) can be implemented as a body 1010 illustrated in FIG. 4. Accordingly, the functional unit 500 can further include various physical components for implementation as the body 1010 in addition to the components illustrated in FIG. 2. According to an embodiment, the functional unit 500 can be referred to as a main body or body portion of a microwave or a cooking appliance, and the digital controller door 100 can be referred to a display door, a smart door or touchscreen door of the cooking appliance.

The OS controller 200 controls various components of the digital controller door 100 (e.g., smart door, touchscreen door or door display, etc.). According to an embodiment, the OS controller 200 of the door can be referred to as a door controller and the function controller 500 can be referred to as a main controller. According to embodiments, the function controller 500 and the OS controller 200 can be referred to in various ways, such as main controller and sub-controller, first controller and second controller, system controller and display controller, or main controller and user interface UI controller, or variations thereof. For example, the controller in the cooking appliance can be referred to as a function controller 550 and the controller in the door can be referred to as display controller.

In addition, the OS controller 200 (e.g., in the door) transmits a predetermined signal to the function controller 550 (e.g., in the microwave oven), and allows the function controller 550 to control the performance of a specific function of the cooking appliance 1000. In addition, the function controller 550 can transmit a signal to the OS controller 200. This allows the function controller 550 to inform the OS controller 200 of a result related to the performance of a specific function of the cooking appliance 1000. The OS controller 200 can operate based on a specific operating system (OS) (e.g., Android). An Android operation system is merely an example, and other types of operating systems can be used, according to embodiments.

According to an embodiment, the function controller 550 and the OS controller 200 can operate independently and can communicate a predetermined signal with each other when there is information to be notified to each other. A type of signal can be based on various communication protocols such as wired communication or wireless communication. According to an embodiment, when the OS controller 200 receives information from the user and is instructed to perform a specific function of the cooking appliance, the OS controller 200 can transmit a specific signal to the function controller 550. In this situation, the function controller 550 operates the functional unit 500 (e.g., main body and components), for example, the body 1010.

The function controller 550 can be embodied as a microcomputer for generating a signal for operating the functional unit 500, for example, the body 1010.

The camera 110 can be disposed on the digital controller door to photograph the outside of the cooking appliance 1000, photograph the surroundings, or photograph a cooking space inside the cooking appliance 1000.

In addition, the camera 110 can be disposed inside the digital controller door 100. The camera 110 can photograph the inside of the cooking appliance 1000 to allow the user to check the cooking state of the food stored therein.

Accordingly, the camera 110 can be disposed to face outwardly of the digital controller door 100 (toward the user) and to face inwardly of the digital controller door 100 (toward the inside of the cooking appliance). In this situation, the display 160 can output an image obtained by photographing the outside out of the cooking appliance or the inside of the cooking appliance based on the cooking state or a state of the function performed by the digital controller door 100.

The communicator 120 (e.g., communication interface, or transceiver) can perform various types of wired or wireless communication functions. The communicator can communicate with another device (e.g., an external server, a hub disposed in a home, or another home appliance) using a communication protocol such as Wi-Fi, BLUETOOTH, or the like.

The speaker/microphone 130 can generate a voice, an alarm sound, etc. for the operation of the cooking appliance 1000, and can receive a predetermined external voice command or an external sound. The speaker/microphone 130 can be integral with each other or can be disposed at different positions.

The sensor 140 senses an environment outside or inside the cooking appliance 1000. For example, the sensor 140 can include a temperature sensor, an illuminance sensor, a human sensor, a humidity sensor, etc.

The display 160 outputs visual information to be provided to a user. The information provided from the display 160 includes a cooking function or state of the cooking appliance 1000 in operation, an interface for controlling the cooking appliance 1000, and information on a surrounding environment in which the cooking appliance 1000 is disposed.

In addition, when the digital controller door 100 operates as an Internet-of-things hub, the display 160 can display various information in addition to cooking related information. In addition, the display 160 can convert a user's touch into an input signal.

The application unit 170 (e.g., memory) stores therein various application programs as executed by the digital controller door 100, and the OS controller 200 can execute the application programs stored in the application unit 170 and can display the execution results on the display 160. For example, the display 160 can be a touchscreen display.

The door fan 180 embodied as the direct current fan is configured to cool heat generated in various electronic devices related to a digital controller door. The door fan 180 can cool the heat generated from the display 160 and/or the OS controller 200.

The OS controller 200 can download various application programs through the communicator 120 and store and install the application programs in the application unit 170.

The application program according to an embodiment of the present disclosure includes an application program directly or indirectly related to the operation or function of the cooking appliance 1000, such as an application program for controlling the cooking of the cooking appliance 1000, an application program related to an image or a video to be displayed during the operation of the cooking appliance 1000, etc. In this situation, the OS controller 200 can control a function of the cooking appliance 1000 by controlling the function controller 550 using the application program.

In addition, the application program according to an embodiment of the present disclosure includes an application program for the digital controller door 100 to operate as the Internet of Things hub.

The AC input unit 510 of the functional unit 500 (e.g., main body portion) receives power required for the cooking appliance 1000 to operate. The supplied power is provided to the function controller 550 and the OS controller 200 through the power supply 520.

The function controller 550 controls the functions of the cooking appliance 1000. In this regard, the function controller 550 receives a signal from the OS controller 200 and controls the functions of the cooking appliance 1000. The function controller 550 can control an operation of each of the cooking appliance function provider 560 (e.g., magnetron, microwave generator, heating coil(s), heater), the inside lamp 570, the outside lamp 580, the ventilation fan (Vent Fan) 590, and the thermistor 595 according to the signal received from the OS controller 200. Hereinafter, the cooking appliance function provider 560, the inside lamp 570, the outside lamp 580, the ventilation fan 590, and the thermistor 595 are referred to as elements or components of the functional unit 500.

The cooking appliance function provider 560 (e.g., magnetron, microwave generator, heating coil(s), heater) generates microwaves or heater heat to cook food stored in the cooking appliance 1000.

The inside lamp 570 is disposed inside the cooking appliance 1000 that is opened and closed by the digital controller door 100. When the digital controller door 100 is opened or closed, the inside lamp 570 can be turned on and off. Alternatively, when the cooking appliance 1000 is cooking the food, the inside lamp 570 can be turned on so that the internal camera can capture an image thereof.

The outside lamp 580 is disposed at a lower end or an upper end of the cooking appliance 1000. When the cooking appliance 1000 is disposed on top of a separate cooktop, the outside lamp 580 can be disposed at a lower end of the cooking appliance 1000.

The ventilation fan 590 discharges heat generated from the cooktop to the outside.

The thermistor 595 is a component disposed in the functional unit 500 (e.g., main body and components) to sense a temperature. One or more thermistors 595 can be disposed at the cooking appliance 1000.

According to an embodiment of the present disclosure, the thermistor 595 can provide information on the sensed temperature to the function controller 550. According to another embodiment of the present disclosure, the thermistor 595 can be included in the sensor 140, and in this situation, information on the sensed temperature can be provided to the OS controller 200 that controls the sensor 140.

The food stored in the cooking appliance 1000 is cooked via the operation of the cooking appliance function provider 560. Even in this process, the function controller 550 and the OS controller 200 can communicate information with each other per a preset time interval.

The OS controller 200 provides a user interface/user experience (UI/UX) function. In addition, the OS controller 200 transmits a predetermined signal to the function controller 550, and the function controller 550 controls the operation of the cooking appliance 1000, for example, the body 1010 or the functional unit 500. In addition, the function controller 550 can control an operation of the cooking appliance function provider 560 and provide an information value generated therefrom during control to the OS controller 200.

Accordingly, the control flow of the OS controller 200 and the function controller 550 is configured such that the OS controller 200 transmits a predetermined signal to the function controller 550 and then receives a predetermined control result from the function controller 550. For example, the OS controller 200 in the door can monitor the function controller 550 in the body of the microwave/cooking appliance.

The OS controller 200 and the function controller 550 can communicate with each other in a wired or wireless manner. The OS controller 200 and the function controller 550 can communicate with each other using various communication protocols, and embodiments of the present disclosure are not limited to a specific communication protocol.

As illustrated in FIG. 2, a communication link via which the function controller 550 transmits predetermined data to the OS controller 200 or performs control is referred to as a F_O link or an uplink. A communication link via which the OS controller 200 transmits predetermined data to the function controller 550 or performs control is referred to as an O_F link or a downlink. However, embodiments of the present disclosure are not limited to a specific name or a direction such as upward/downward, and the links can be distinguished from each other based on a direction of data transmission between the components 550 and 200.

In an embodiment of the present disclosure, the link can physically use one or more lines or can use one or more communication media. In addition, in accordance with the present disclosure, a name is separately given to each data transmission direction in order to distinguish logically the data transmission directions from each other.

According to an embodiment of the present disclosure, in the wired communication, the OS controller 200 and the function controller 550 can communicate with each other using a communication protocol such as Universal asynchronous receiver/transmitter (UART) and Universal Serial Bus (USB).

According to an embodiment of the present disclosure, in the wireless communication, the OS controller 200 and the function controller 550 can communicate with each other using a communication protocol such as ZIGBEE, Wi-Fi, and BLUETOOTH.

Each of the OS controller 200 and the function controller 550 can include a separate memory (e.g., internal memory), and can store, in the memory, function result information or error information generated in the process of performing a function.

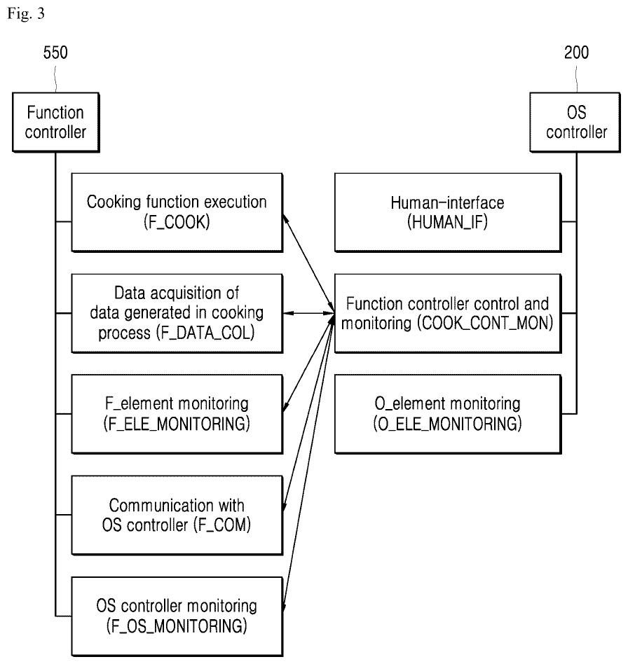

FIG. 3 is a diagram illustrating categories of functions performed by an OS controller and a function controller according to an embodiment of the present disclosure. Each function includes a situation in which each of the controllers 200 and 550 performs a corresponding function.

Each of the controllers 200 and 550 can perform the functions simultaneously or sequentially.

The function controller 550 controls the functional unit 500 that provides a cooking function. The operating system (OS) controller 200 transmits a signal to the function controller 550. The function controller 550 instructs an operation of the functional unit 500. The operating system (OS) controller 200 controls the digital controller door 100 that provides a human interface.

The functions performed by the function controller 550 include cooking function execution F_COOK. In addition, the functions performed by the function controller 550 include data acquisition F_DATA_COL of data generated in the cooking process. In addition, functions performed by the function controller 550 include F_element monitoring F_ELE_MONITORING. In addition, functions performed by the function controller 550 include communication F_COM with the OS controller 200. In addition, functions performed by the function controller 550 include OS controller monitoring F_OS_MONITORING. The OS controller 200 and the function controller 550 can operate independently, and can inform the state or operation status of each component via transmission and reception of signals to and from each other.

In the cooking function execution F_COOK, the function controller 550 controls the cooking appliance function provider 560 so that the cooking appliance 1000 can perform cooking. Alternatively, in addition to cooking such as heating, a function in which the function controller 550 controls the operation of the inside lamp 570, the outside lamp 580, and the ventilation fan 590 can be included in the cooking function execution F_COOK.

The function of the data acquisition F_DATA_COL of the data generated in the cooking process is a function of the function controller 550 collecting or acquiring various result values calculated by the elements or the components of the functional unit 500 or data related to the current state in the cooking function execution F_COOK process.

The F_element monitoring (F_ELE_MONITORING) refers to a function in which the function controller 550 monitors elements or components of the functional unit 500. The function controller 550 can monitor whether each element or component operates properly or whether each element or component operates according to a previous instruction to perform a function.

The communication F_COM function with the OS controller means that the function controller 550 provides data obtained in F_DATA_COL, F_ELE_MONITORING, etc. to the OS controller 200.

The OS controller monitoring F_OS_MONITORING function refers to a function in which the function controller 550 transmits a predetermined packet to the OS controller 200 to check whether the OS controller 200 is operating properly.

The F_COM and F_OS_MONITORING functions can be implemented as one function. That is, even when the cooking function is not performed, the function controller 550 transmits the data obtained through the F_ELE_MONITORING to the OS controller 200. The function controller 550 can check whether the OS controller 200 is in a normal state or an abnormal state based on whether the OS controller 200 has transmitted an acknowledgement (ACK) response to the transmitted data. For example, the normal state can refer to an error free operating state, and the abnormal state can refer to an operating state that includes one or more errors or problems.

The functions performed by the OS controller 200 include a human-interface HUMAN_IF. In addition, the functions performed by the OS controller 200 include function controller control and monitoring COOK_CONT_MON. In addition, the functions performed by the OS controller 200 include O_element monitoring O_ELE_MONITORING. In this regard, one embodiment of the function controller control and monitoring COOK_CONT_MON is that the OS controller 200 transmits a predetermined signal to the function controller 550 so that the function controller 550 can control the functional unit 500, that is, the body 1010.

The human-interface HUMAN_IF function refers to a function in which the OS controller 200 outputs a user interface, such as various information or a menu for controlling the cooking appliance, and receives a user's touch input or user command thereto.

One embodiment of the function controller control and monitoring COOK_CONT_MON is that the OS controller 200 provides a signal to the function controller 550 so that the function controller 550 controls the operation of the functional unit 500, that is, the body 110. In addition, one embodiment of the function controller control and monitoring COOK_CONT_MON is that predetermined information collected by the function controller 550, for example, information for monitoring the state or an operation status of the functional unit 500, that is, the body 110, is transmitted to the OS controller 200 in a form of a predetermined wired or wireless signal.

More specifically, when the user selects a specific cooking function in the human-interface HUMAN_IF function, the OS controller 200 can instruct the function controller 550 to execute the cooking function.

In addition, the OS controller 200 can perform monitoring to receive values of the operation states or cooking results of the elements or the components constituting the functional unit 500 from the function controller 550. All of these functions are included in the function controller control and monitoring COOK_CONT_MON. Accordingly, the function controller control and monitoring COOK_CONT_MON of the OS controller 200 is related to five functions of the function controller 550.

The O_element monitoring O_ELE_MONITORING refers to a function in which the OS controller 200 monitors the elements or the components of the digital controller door 100. The OS controller 200 can monitor whether each of the elements or the components operates properly, or whether each element or component operates according to a previous instruction to perform a function.

As shown in FIG. 3, the function controller 550 and the OS controller 200 perform respective given functions independently but in association with each other. Accordingly, the function controller 550 checks whether the OS controller 200 operates normally or not in the process of performing the function, while the OS controller 200 checks whether the function controller 550 operates normally or not in the process of performing the function. When an abnormality occurs in a component of one of the function controller 550 (e.g., main controller) and the OS controller 200 (e.g., door controller), the other of the function controller 550 and the OS controller 200 can cope with this situation or address the abnormality or error.

Hereinafter, a schematic outer appearance and configuration of a cooking appliance including the digital controller door 100 of the present disclosure will be described. This corresponds to one embodiment of the present disclosure, and a scheme and a direction in which the digital controller door 100 is opened can be implemented in various ways.

The present disclosure relates to a scheme for controlling a cooking appliance using a digital controller door disposed at a front surface of the cooking appliance.

According to the present disclosure, a door of a microwave oven disposed on top of an oven or a gas stove acts as an LCD screen (an embodiment of a display). The Android board (an embodiment of an OS controller) of the LCD screen and the microcomputer (an embodiment of a function controller) of the microwave oven cooperate with each other. An LCD component operates according to various operating/external environments of the microwave oven or controls a specific function of the microwave oven.

The digital controller door (e.g., display door, or smart door) of the present disclosure can be combined with the cooking appliance to open and close the inside of the cooking appliance. An embodiment of the cooking appliance of the present disclosure is a microwave oven. However, embodiments of the present disclosure is not limited thereto. An embodiment of the cooking appliance including the digital controller door of the present disclosure includes each of various cooking appliances which includes a door equipped with a display such as an LCD providing various user interfaces such as a touch screen, and is capable of storing and cooking food therein.

A display can be mounted on a front surface of a digital controller door provided in the cooking appliance of the present disclosure to provide various information to a user. The user can know the cooking state of the cooked food on the display.

In addition, when the display is connected to another home appliance to serve as a hub of the home appliances, the information other than cooking food can be obtained through the display. In addition, a command for cooking and various other commands can be input to the display in a touch manner.

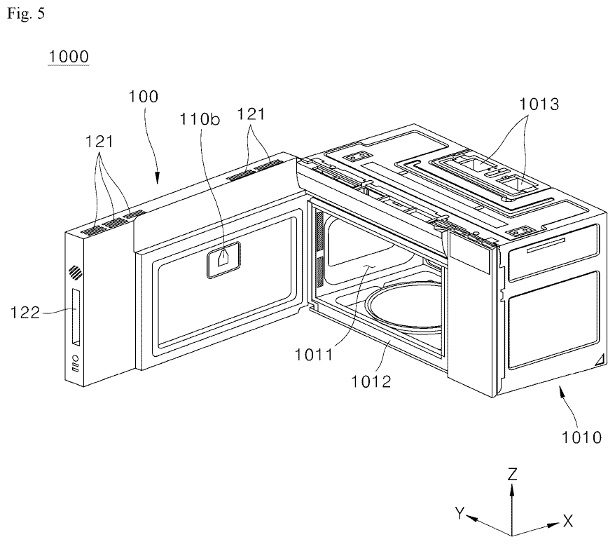

FIG. 4 is a perspective view illustrating a cooking appliance according to an embodiment of the present disclosure. FIG. 5 is a diagram illustrating a state in which the digital controller door 100 is opened in FIG. 4.

The cooking appliance according to the embodiment can be disposed at a position spaced apart from the heating cooking device in the vertical direction above a position where a heating-type oven, a gas stove, etc. are disposed.

Due to the arrangement of the cooking appliance, a user can conveniently use the heating cooking device including the cooking appliance. In addition, the cooking appliance can serve as a hood of the heating cooking device disposed under the cooking appliance. In this situation, the cooking appliance can include components for use as the hood.

The cooking appliance can cook food using microwaves belonging to electromagnetic waves and/or heater heat. The cooking appliance can include the body 1010 in which a cavity 1011 is formed, and the digital controller door 100 configured to open and close the cavity 1011. The body 1010 is an embodiment of the functional unit 500 of FIG. 2 as described above. According to an embodiment of the present disclosure, the body 1010 can act in the same manner as the functional unit 500 can. Alternatively, according to an embodiment of the present disclosure, the components of the functional unit 500 can be implemented in the body 1010. Accordingly, in various embodiments, the functional unit 500 and the body 1010 can be interchangeable with each other.

Food to be cooked can be placed in the cavity 1011. The digital controller door 100 can be disposed in front of the cavity 1011 and pivotally mounted at the body 1010 to open and close the cavity 1011.

A ventilation hole 1013 for discharging air suctioned from a suction unit provided at a lower portion of the body 1010 to the outside can be provided at an upper portion of the body 1010. A suction unit can be provided at a lower portion of the body 1010 of the cooking appliance. Accordingly, the cooking appliance can serve as a hood that sucks air discharged from the heating cooking device disposed below the cooking appliance and discharges the air to the outside.

The body 1010 can further include a front panel 1012 provided along an edge of an inlet of the cavity 1011. One surface of the front panel 1012 faces one surface of a choke member when the digital controller door 100 is closed, thereby closing the cavity 1011.

The front panel 1012 can be constructed to surround the edge of the inlet of the cavity 1011 and protrude in a frontward direction and has a predetermined width. Accordingly, when the digital controller door 100 is closed, the edge portion of the digital controller door 100 and the cavity 111 can overlap each other.

Due to this structure, the front panel 1012 can seal the cavity 1011 in a state in which the digital controller door 100 has been closed, thereby preventing oil, moisture, oil vapor, etc. generated during the cooking process of the food placed in the cavity 1011 from being leaked out to the outside through the inlet of the cavity 1011.

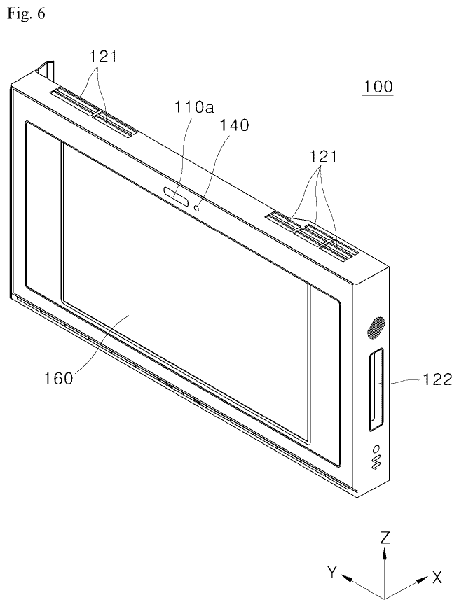

FIG. 6 is a perspective view illustrating a digital controller door (e.g., display door) of a cooking appliance according to an embodiment of the present disclosure.

The digital controller door 100 can include controller hardware (e.g., a hardware chip) or controller software (software including programs) that executes a predetermined algorithm and performs following tasks based on sensing results from various sensors disposed at the cooking appliance or the door and an operating state of the cooking appliance.

In FIGS. 4 to 6, a reference numeral 121 denotes a through hole through which air is introduced or discharged. A first camera 110a and the sensor 140 can be disposed on the front surface of the digital controller door 100. The sensor 140 includes a human sensor, an illuminance sensor, etc.

The display 160 is used to control the cooking appliance 1000 or displays an operation process in the cooking appliance 1000. The ventilation hole 1013 can include a suction portion defined at a lower end of the body 1010 and a discharge portion defined at an upper end of the body 1010. A handle 122 is disposed on one side of the digital controller door 100 such that the user can open and close the digital controller door 100 using the handle.

A second camera 110b can be disposed on an inner side surface of the digital controller door 100, and the second camera 110b can photograph the inside of the cavity 1011 to check the cooking state.

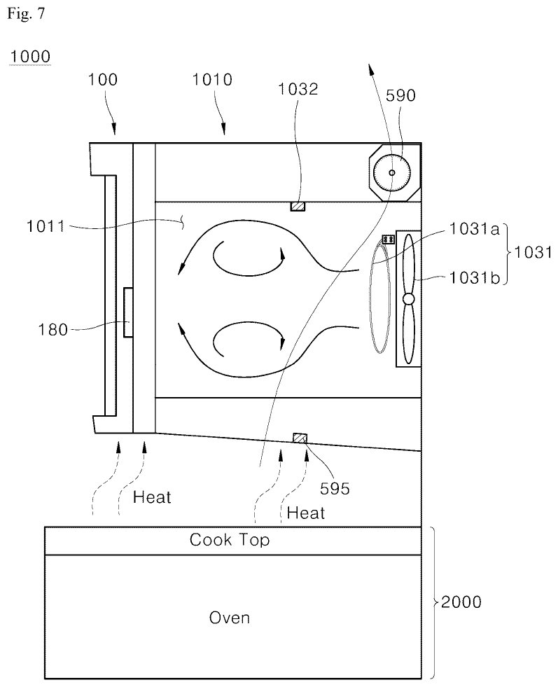

FIG. 7 is a schematic view illustrating a position where a cooking appliance is disposed according to an embodiment of the present disclosure. In FIG. 7, the flow of air is indicated by a solid line arrow, and the transfer direction of heat is indicated by a hidden line arrow. A heating cooking device 2000 can include, for example, an oven and a cooktop disposed on top of the oven.

The cooking appliance can include a convection-based heating device 1031 and a microwave generating device 1032 to heat food accommodated in the cavity 1011.

The convection-based heating device 1031 can generate heat to heat food, and the microwave generating device 1032 can generate microwaves to heat food. The user can select and operate one of the convection-based heating device 1031 or the microwave generating device 1032 to heat and cook food.

The convection-based heating device 1031 can include a convection heater 1031a and a convection fan 1031b. The convection heater can generate heat to heat food accommodated in the cavity 1011. The convection fan 1031b can force the air in the cavity 1011 heated by the convection heater 1031a to flow in the cavity 1011.

When the convection fan 1031b operates, the heated air can be smoothly convectively circulated in the cavity 1011, and accordingly, heat is uniformly supplied to the entire cavity 1011, so that an entirety of the food accommodated in the cavity 1011 can be evenly cooked.

In order to prevent the display 160 provided in the digital controller door 100 from being overheated by the heated air coming up from the heating cooking device disposed under the cooking appliance, resulting in malfunction of or damage to the display 160, it is advantageous to cool the display 160 and prevent external heat from being transferred to the display 160. The door fan 180 and the ventilation fan 590 can perform the above role.

The door fan 180 can be disposed inside the digital controller door 100 (e.g., the door fan can be inside the smart display door). The door fan 180 can effectively cool the display 160 by flowing air toward the rear surface of the display 160.

In addition, the air flow discharged from the door fan 180 to the outside of the digital controller door 100 (e.g., display door) can form an air curtain to block the heat rising from the heating cooking device disposed under the cooking appliance.

The ventilation fan 590 can be disposed at a top of the body 1010 and can be disposed in a flow path of the ventilation hole 1013. The ventilation fan 590 can allow air coming up from the heating cooking device to flow to the ventilation hole 1013 to discharge the air to out of the cooking appliance.

Accordingly, when the ventilation fan 590 operates, a significant portion of the heated air coming up from the heating cooking device flows to the ventilation hole 1013 formed in the body 1010, and the flow rate of air heading to the display 160 of the digital controller door 100 can be relatively reduced. As a result, the flow rate of the heated air directed to the display 160 of the digital controller door 100 (e.g., display door) is reduced, thereby suppressing overheating of the display 160.

In order to block overheating of the display 160, it can be advantageous to appropriately use the door fan 180 and the ventilation fan 590. Since one of main purposes of the door fan 180 is to prevent the overheating of the display 160, the door fan 180 can operate in a low-speed rotation mode and a high-speed rotation mode based on the temperature condition of air approaching the digital controller door 100.

The door fan 180 has a small amount of air blown in the low-speed rotation mode and a large amount of air blown in the high-speed rotation mode. Therefore, the temperature of the display 160 can be effectively lowered by the door fan operating in the low-speed rotation mode when the temperature of the air is low and by the door fan operating in the high-speed rotation mode when the temperature of the air is high.

In order to reliably suppress the overheating of the display 160, it is advantageous to operate both the door fan 180 and the ventilation fan 590 and operate the door fan 180 in the high-speed rotation mode.

The thermistor 595 disposed at a bottom of the cooking appliance 1000 can sense the heat from the heating cooking device disposed under the cooking appliance 1000. In addition, the auto ventilation function can operate upon sensing the heat.

In FIG. 3, the function controller 550 can perform the F_element_monitoring F_ELE_MONITORING, and similarly, the OS controller 200 (e.g., door controller) can perform the O_element monitoring O_ELE_MONITORING.

In this regard, the door fan 180 can be controlled by the OS controller 200 (e.g., door controller) to cool the heat applied to the digital controller door 100, particularly the display 160.

The OS controller 200 (e.g., door controller) can control the activation/deactivation, an operation level, for example, a rotation speed of the door fan 180 embodied as the DC fan based on an operation state of the digital controller door 100, particularly, a state about whether the display 160 is turned on or off.

In addition, the OS controller 200 (e.g., door controller) can control the activation/deactivation, the operation level of the door fan 180 or the rotation speed of the door fan 180 based on an operation state of the function unit 500, particularly, whether the function unit is in a heating operation state.

In addition, the OS controller 200 (e.g., door controller) can control the activation/deactivation, the operation level of the door fan 180 or the rotation speed of the door fan 180 based on an operation state of the ventilation fan 590.

In addition, the OS controller 200 (e.g., door controller) can control the activation/deactivation, the operation level of the door fan 180 or the rotation speed of the door fan 180 based on an operation state of the heating cooking device 2000 such as an oven or a cooktop, for example, upon detection that heat is generated from the heating cooking device 2000.

Accordingly, the OS controller 200 (e.g., door controller) can control the door fan 180 to cool the cooking appliance 1000 and the digital controller door 100 (e.g., display door, touchscreen door, smart display door, etc.).

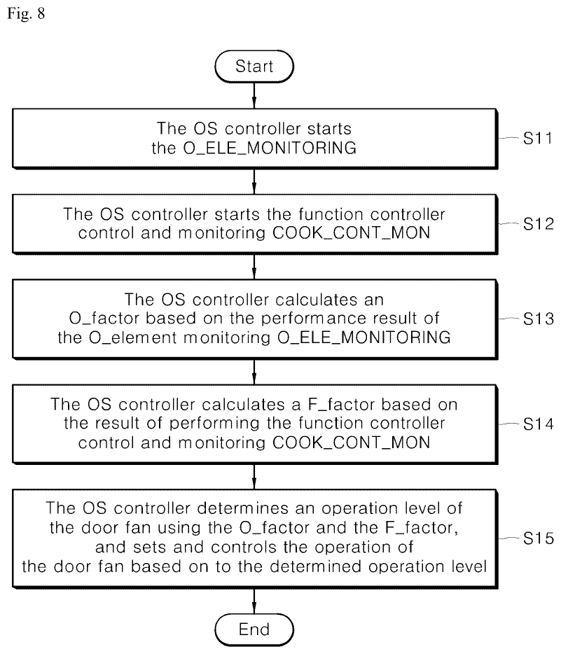

FIG. 8 is a diagram illustrating a process in which the OS controller (e.g., door controller) controls an operating state of a door fan according to an embodiment of the present disclosure.

The OS controller 200 (e.g., door controller) starts the O_ELE_MONITORING in S11. The O_ELE_MONITORING includes monitoring the operation state of each of the components constituting the digital controller door 100 (e.g., display door) or information sensed by a sensor (e.g., starts monitoring of parts in the microwave oven main portion).

In addition, the OS controller 200 (e.g., door controller) starts the function controller control and monitoring COOK_CONT_MON in S12 (e.g., starts monitoring of the main controller in the oven). To this end, the OS controller 200 can periodically receive information from the function controller 550. In this regard, in an embodiment of the function controller control (e.g., main controller), the OS controller 200 (e.g., door controller) transmits a predetermined signal to the function controller 550 so that the function controller 550 can control the function unit 500 (e.g., main oven portion and components), that is, the body 1010.

Thereafter, the OS controller 200 (e.g., door controller) calculates an O_factor (e.g., operating factor or condition) based on the performance result of the O_element monitoring O_ELE_MONITORING in S13. The O_factor can be a set of one or more values. Alternatively, the O_factor can be a set of one or more true/false values. Alternatively, the O_factor can be a set of one or more on/off values. In another example, the O_factor can include all or some of the elements of the above-described sets. For example, the main oven portion can refer to the parts of the cooking appliance that do not include the display door.

Similarly, the OS controller 200 (e.g., door controller) calculates a F_factor (e.g., function factor or condition) based on the result of performing the function controller control and monitoring COOK_CONT_MON in S14. The F_factor can be a set of one or more values. Alternatively, the F_factor can be a set of one or more true/false values. Alternatively, the F_factor can be a set of one or more on/off values. In another example, the F_factor can include all or some of the elements of the above-described sets.

The OS controller 200 (e.g., door controller) determines an operation level of the door fan 180 using the O_factor and the F_factor, and sets and controls the operation of the door fan 180 based on to the determined operation level in S15. The operation level refers to a level of cooling power provided by the door fan 180. The operation level can be linearly increased or decreased and can be increased or decreased in a stepwise manner.

In an embodiment in which the operation level linearly increases or decreases, the OS controller 200 (e.g., door controller) can linearly change the rotational speed (e.g., rpms) of the door fan 180 or can linearly change the magnitude of the voltage or current to be applied to the door fan 180.

In an embodiment in which the operation level is increased or decreased in a stepwise manner, the OS controller 200 (e.g., door controller) can set the rotation speed of the door fan 180 to specific values or set the magnitude of the voltage or current to be applied to the door fan 180 to specific values.

In an embodiment in which the operation level is increased or decreased in a stepwise manner, the operation level can be composed of two or more levels such as 0 (Off), 1 (low), and 2 (high). The number of the operation levels can vary.

An embodiment in which the operation level is set based on the rotation speed of the door fan 180 will be described. The rotation speed can be set to a rotation per minute (rpm) or can be set to a specific level (e.g., low, middle, high, off). When there are two or more door fans 180, the operation level can be set based on the number of door fans 180 which can operate. This is one embodiment. Alternatively, the operation level can be set based on a combination thereof.

Values constituting the O_factor are as follows. According to an embodiment of the present disclosure, the O_factor includes an operation state (On/Off) of the display 160. According to another embodiment of the present disclosure, the O_factor includes a value of the temperature sensed by the sensor 140 in the display door. According to still another embodiment of the present disclosure, the O_factor includes an operation state (On/Off) of the speaker or microphone or an operation state (On/Off) of the application 170.

Values constituting the F_factor are as follows. According to an embodiment of the present disclosure, the F_factor includes an operation state (On/Off) of the cooking appliance function provider 560 of the function unit 500. According to another embodiment of the present disclosure, the F_factor includes a value of a temperature sensed by the thermistor 595 of the functional unit 500 (e.g., the thermistor 595 can be disposed at a bottom of the main oven portion). According to still another embodiment of the present disclosure, the F_factor includes an operating state (On/Off) of the ventilation fan 590 of the functional unit 500.

The O_factor or the F_factor can include a specific temperature value and can include a true/false value about whether a specific temperature value exceeds a preset reference value or an exceeding/equal/lower value whether a specific temperature value exceeds or equal to or is lower than a preset reference value.

The OS controller 200 (e.g., door controller) can assign a weight or a priority to each of the factors. Alternatively, a specific factor can be determined at a first priority. For example, the OS controller 200 (e.g., door controller) can determine the detection value of the thermistor 595 among the F_factors at the highest priority and can determine the activation/deactivation of the door fan 180 or the operation level thereof, based on the detection value of the thermistor 595. For example, the temperature sensed under the smart microwave oven can be assigned a highest priority (e.g., due to the cook top or oven 2000).

The embodiment of FIG. 8 is summarized as follows.

The function controller 550 (e.g., main controller) controls the function unit 500 (e.g., main oven portion and components) that provides a cooking function. The OS controller 200 (e.g., door controller) controls the digital controller door 100 (e.g., display door) that instructs the operation of the function unit 500 (e.g., main over portion) and provides a human interface or user interface. The OS controller 200 (e.g., door controller) sets an operation level of the door fan 180 of the digital controller door 100 (e.g., display door) based on state information of each of the components of the function unit 500 or the digital controller door 100 in the process of controlling the digital controller door 100. For example, the operating level of the door fan 180 inside the display door can be automatically and dynamically adjusting based on different conditions and situations.

The operation level of the door fan 180 can be determined and set in various ways. First, the operation level of the door fan 180 can include on/off.

Second, the operation level of the door fan 180 can include three or more levels, such as a first level, a second level, and a third level.

In this situation, the first level corresponds to an off state or a level providing the lowest cooling power. The second level LV2 is in an on state and corresponds to a level that provides a cooling force higher than the first level LV1. The third level LV3 is in an on state and corresponds to a level that provides a cooling force higher than the second level LV2 (e.g., LV1<LV2<LV3). However, embodiments are not limited thereto, and four or more levels of operating speeds can be used for driving the door fan 180.

When the rotational speed of the door fan 180 is set to the first level, the second level, or the third level according to an embodiment of the present disclosure, the rotational speed of the door fan 180 at the first level is lower than the rotational speed of the door fan 180 at the second level. In addition, the rotation speed of the door fan 180 at the second level is lower than the rotation speed of the door fan 180 at the third level (e.g., LV1<LV2<LV3). In this regard, the rotation speed of the door fan 180 at the first level can be 0.

According to another embodiment of the present disclosure, when the magnitude of the voltage to be applied to the door fan 180 is set to the first level, the second level, or the third level, the magnitude of the voltage to be applied to the door fan 180 at the first level is lower than the magnitude of the voltage to be applied to the door fan 180 at the second level. In addition, the magnitude of the voltage to be applied to the door fan 180 at the second level is lower than the magnitude of the voltage to be applied to the door fan 180 at the third level. In this regard, the magnitude of the voltage to be applied to the door fan 180 at the first level can be 0.

According to another embodiment of the present disclosure, when the magnitude of the current to be applied to the door fan 180 is set to the first level, the second level, and the third level, the magnitude of the current to be applied to the door fan 180 at the first level is lower than the magnitude of the current to be applied to the door fan 180 at the second level. In addition, the magnitude of the current to be applied to the door fan 180 at the second level is lower than the magnitude of the current to be applied to the door fan 180 at the third level. In this regard, the magnitude of the current to be applied to the door fan 180 at the first level can be 0.

According to another embodiment of the present disclosure, when there are two or more door fans, the first level, the second level, and the third level can be based on the number of operating door fans.

For example, when there are two door fans, in the first level, both door fans can be in an off state. In the second level, only one of the two door fans is in an on state and the other thereof is in an off state. In the third level, both door fans operate. However, embodiments are not limited thereto and three or more fans can be in the display door.

In addition, each of the first, second, and third levels can be subdivided into various sub-levels.

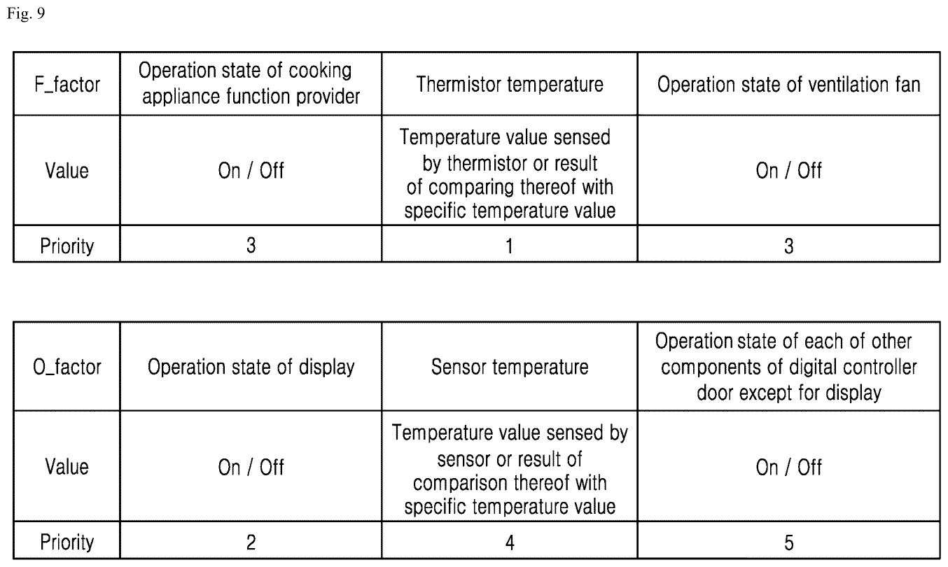

According to an embodiment of the present disclosure, the OS controller 200 (e.g., door controller) can set the operation level of the door fan based on a priority of the state information F_factor obtained from the function controller controlling the function unit and the state information O_factor of the component of the digital controller door. This will be described with reference to FIGS. 9 to 12.

Referring to FIG. 8, the operating system (OS) controller 200 (e.g., door controller) that controls the digital controller door 100 (e.g., display door) collects state information of each of the components of the function unit 500 (e.g., components in the main oven portion, such as microwave generator, internal lamp, internal camera, vent fan(s) etc.) or components of the digital controller door 100 (e.g., the parts of the display door, such as a touchscreen display, external camera, external lamp, fan(s)). The OS controller 200 (e.g., door controller) sets the operation level of the door fan of the digital controller door 100 (e.g., display door) based on the collected state information. According to one embodiment of the present invention, a controller providing general control functions (e.g., a controller disposed on a digital controller door or a controller disposed on a functional unit) can perform the above-described function(s). The OS controller (e.g., door controller) and/or the function controller (e.g., main controller in the main oven portion) are embodiments of controller. Also, according to an embodiment, the door controller and the main oven controller can be parts of a same controller (e.g., different sections on a same chip or printed circuit board, etc.).

FIG. 9 is a diagram showing a table about factors according to an embodiment of the present disclosure. The table can be stored in the OS controller 200 (e.g., door controller). FIG. 9 shows a situation in which high priorities 1 and 2 are respectively assigned to a factor related to the operating state of the thermistor 595 and a factor related to the operating state of the display 160.

An embodiment of the F_factor includes an operation state On/Off of the cooking appliance function provider 560, a temperature value sensed by the thermistor 595 of the functional unit 500 or a result of comparing thereof with a specific temperature value, and the operation state On/Off of the ventilation fan 590 of the functional unit 500.

An embodiment of the O_factor includes an operation state (e.g., an operation state of LCD) On/Off of the display 160, a temperature value sensed by the sensor 140 in the display door or a result of comparison thereof with a specific temperature value, and an operation state On/Off of each of the other components of the digital controller door (e.g., display door) except for the display 160.

In addition, the OS controller 200 (e.g., door controller) can preset a priority of each of factors. In another example, this priority can be changed based on an external situation or other conditions, or set by a user.

The values of the factors are collected and stored by and in the OS controller 200. An operation level of the door fan is set based on the collected factors.

FIG. 10 is a diagram illustrating a process of setting an operation level of a door fan in the display door based on each of factors according to an embodiment of the present disclosure.

The OS controller 200 (e.g., door controller) can set the operation level of the door fan to Off/Low/High as examples of the first level, the second level, and the third level, based on the temperature detected by the thermistor and the operating state of the display among the factors of FIG. 9. The rotational speed of the door fan at Low is lower than that of the door fan at High. Alternatively, the number of door fans operating at Low is smaller than the number of door fans operating at High.

In FIG. 10, the OS controller 200 (e.g., door controller) checks whether the temperature sensed by the thermistor 595 is higher than Tl (e.g., 35 degrees Celsius) in S21. When, based on the check result, the sensed temperature is lower than or equal to TI (S21-Yes), the OS controller 200 (e.g., door controller) checks the operation state of the display in S22. When, based on the check result, the display is in the Off state, the OS controller 200 turns off the door fan 180 in S23. When the display is in the On state, the OS controller 200 sets the operation level of the door fan 180 to Low in S24. In addition, the door fan 180 operates at the set level.

On the other hand, when the temperature sensed by the thermistor 595 exceeds TI at S21, the OS controller 200 (e.g., door controller) sets the operation level of the door fan 180 to High in S25. In addition, the door fan 180 operates according to the set level.

The embodiment of FIG. 10 shows a cooling algorithm in which the OS controller 200 (e.g., door controller) sets the optimal operation level of the door fan 180 based on a combination of the temperature detected by the thermistor 595 and the operating state of the digital controller door 100, which can improve user convenience and enhance safety. For example, a user may prefer that the door fan operate at a lower speed to reduce noise in most situations, and to only operate at a high speed (noisy) when safety or preventing overheating of the display door is a potential issue or concern.

Referring to FIG. 10, when the display 160 is an On (Activated), the OS controller 200 (e.g., door controller) controls the operation level of the door fan (e.g., DC Fan) to be set to Low to maintain the temperature of the basic component. In addition, when the temperature of the cooktop 2000 as sensed by the thermistor 595 is higher than or equal to a predetermined level, the OS controller 200 (e.g., door controller) automatically changes the operation level of the door fan (DC Fan 180) into High to increase the cooling power.

An embodiment of FIG. 10 is summarized as follows. When the temperature sensed by the thermistor 595 of the function unit 500 (e.g., main oven portion) among the F_factors is equal to or lower than the first reference temperature Tl (e.g., 35 degrees Celsius) and the display 160 of the digital controller door 100 (e.g., smart display door) is in the off state, the OS controller 200 (e.g., door controller) sets the operation level of the door fan 180 to the first level.

In addition, when the temperature sensed by the thermistor 595 is equal to or lower than the first reference temperature Tl (e.g., 35 degrees Celsius) and the display 160 of the digital controller door 100 is in the On state, the OS controller 200 (e.g., door controller) sets the operation level of the door fan 180 to the second level.

Further, when the temperature sensed by the thermistor exceeds the first reference temperature Tl (e.g., 35 degrees Celsius), the OS controller 200 (e.g., door controller) sets the operation level of the door fan 180 to the third level.

The condition under the OS controller (e.g., door controller) controls the door fan as in the embodiment of FIG. 10 are summarized in Table 1 as set forth below.

TABLE 1

| Thermistor | Operation state | Operation level |
|---|---|---|
| Temperature (T) | of display | of door fan |
| T =< T1 (e.g., 35 C.) | Off | Off |
| | On | Low |
| T > T1 (e.g., 35 C.) | Off | High |
| | On | |

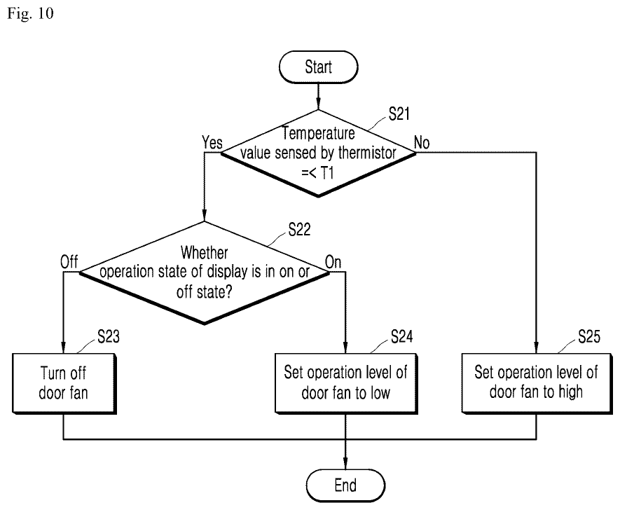

FIGS. 11 and 12 are diagrams illustrating a configuration of factors and a process of setting an operation level of a door fan according to another embodiment of the present disclosure.

FIG. 11 is a diagram showing a table about factors according to another embodiment of the present disclosure. This table can be stored in the OS controller 200 (e.g., door controller). Unlike FIG. 9, FIG. 11 is a situation in which the highest priority 1 is given to each of the operating state of the cooking appliance function provider (e.g., microwave generator/heat generator) and the operating state of the ventilation fan belonging to the F_factor, and priorities of 2 and 3 are respectively given to a factor related to the operating state of the thermistor 595 belonging to the F_factor and an operation state of the display 160 belonging to the O_factor. Descriptions of other factors are referred to in FIG. 9.

FIG. 12 is a diagram illustrating a process of setting an operation level of a door fan based on each of factors according to another embodiment of the present disclosure. FIG. 12 illustrates an embodiment in which the OS controller 200 (e.g., door controller) sets the operation level of the door fan 180 to high (e.g., the third level) in response to that the ventilation fan 590 or the cooking appliance function provider 560 such as a microwave oven (MWO) is operating regardless of the temperature of the cooktop 2000. For example, if either one of the vent fan is on or food is being cooked, then the door fan can be set to high.

The OS controller 200 (e.g., door controller) checks whether the ventilation fan 590 or the cooking appliance function provider 560 such as the MWO related to the factors of FIG. 11 is operating in S20. In response to that the ventilation fan 590 or the cooking appliance function provider 560 being in operation, the OS controller 200 (e.g., door controller) sets the operation level of the door fan 180 to High in S25. In addition, the door fan 180 operates according to the set level.

The OS controller 200 (e.g., door controller) checks whether the ventilation fan 590 or the cooking appliance function provider 560 such as the MWO is operating in S20. In response to that the ventilation fan 590 or the cooking appliance function provider 560 is not in operation, the process proceeds to S21. This has been described above with reference to FIG. 10.

FIGS. 9 to 12 show a process in which the OS controller 200 (e.g., door controller) performs monitoring a state of a specific component and sets an operation of the door fan 180 accordingly. Through such a process, the temperature of the components of the cooking appliance 1000, particularly, the digital controller door 100 can be prevented from being excessively high. The priority can be preset or can be adjusted by the OS controller 200 (e.g., door controller).

FIGS. 9 to 12 are about a configuration in which an operation level of the door fan 180 is set based on a state of a specific component. In this regard, the OS controller 200 (e.g., door controller) can precisely control the operation level of the door fan 180 further based on a temporary element, which can improve user convenience, enhance safety and improve the lifespan of components within the cooking appliance and display door.

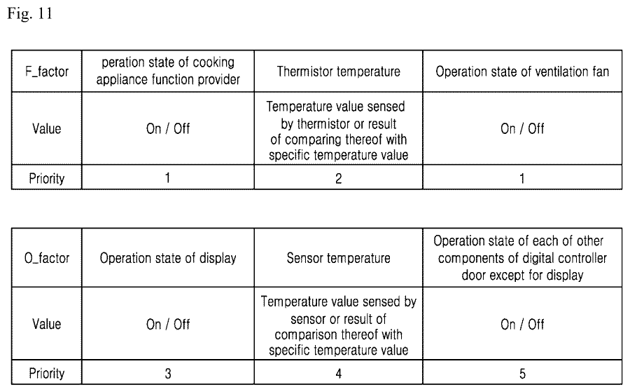

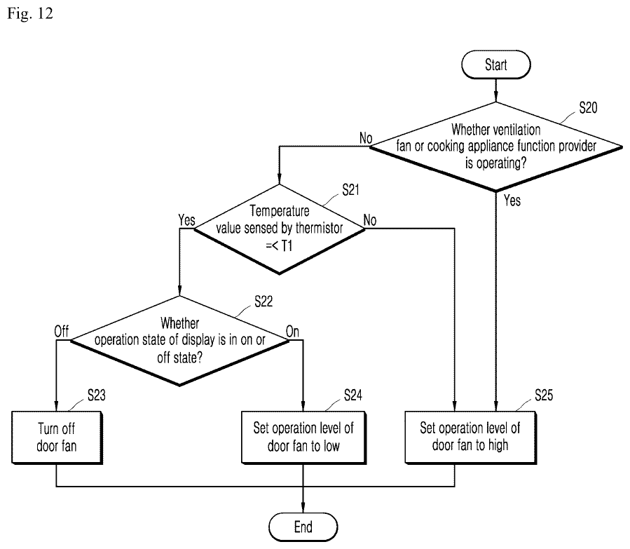

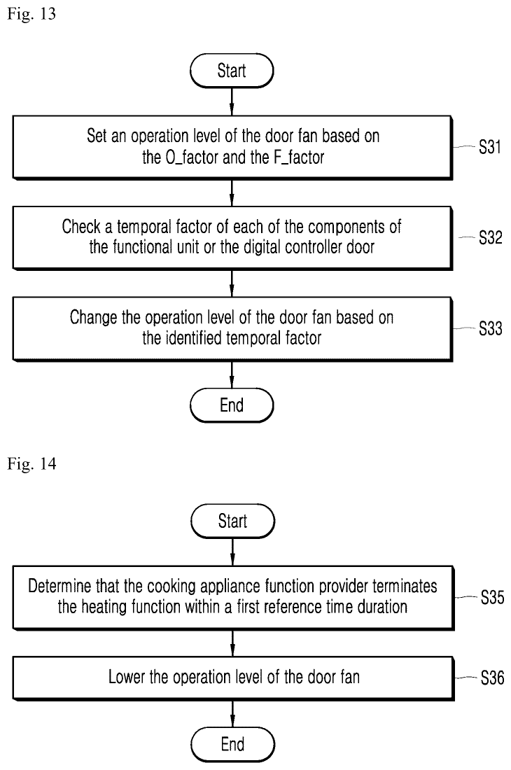

FIG. 13 is a diagram illustrating a process in which an OS controller (e.g., door controller) sets an operation level based on an operation time duration of each component or a timing at which an operation is to be terminated later, according to an embodiment of the present disclosure

As described above with reference to FIGS. 8 to 12, the OS controller 200 (e.g., door controller) sets the operation level of the door fan 180 based on the O_factor and the F_factor in S31. In addition, while the door fan 180 operates according to the operation level, the OS controller 200 (e.g., door controller) checks a temporal factor of each of the components of the functional unit 500 or the digital controller door 100 in S32. The temporal factor includes any one or more of a scheduled end time of a currently operating function or a time duration for which a currently operating function has lasted.

For example, the OS controller 200 (e.g., door controller) can identify, as the temporal factor, a timing at which cooking is scheduled to be terminated when the cooking appliance 1000 is being cooked. Alternatively, the OS controller 200 (e.g., door controller) can identify, as the temporal factor, a time duration for which the operation of the ventilation fan 590 of the cooking appliance 1000 has been maintained after the ventilation fan 590 of the cooking appliance 1000 starts to operate. In another example, the OS controller 200 (e.g., door controller) can also collect information related to temperature (e.g., temperature sensed by the thermistor under the main portion of the oven or temperature sensed by the sensor in the display door).

Then, the OS controller 200 (e.g., door controller) can change the operation level of the door fan 180 based on the identified temporal factor in S33.

For example, in a situation in which cooking is in progress and the door fan 180 can operate at a high level. In this regard, the cooking is scheduled to be terminated after 5 seconds. In this situation, after cooking has finished, the OS controller 200 (e.g., door controller) can lower the operation level of the door fan 180 to a middle or low level.

Alternatively, when it is expected that the display 160 will be turned off soon after performing a predetermined operation (e.g., when a video ends within 30 seconds and there is no person nearby based on a result of checking the sensing result from the sensor 140), the OS controller 200 (e.g., door controller) can lower the operation level of the door fan 180 to the middle or low level. For example, the display fan can be turned on while a user is watching a video on the display of the display door (e.g., online streaming, etc.) and then turn the door fan off or set it to a lower level once the video has stopped playing.

Similarly, when the ventilation fan 590 is operating for a long time duration (e.g., 20 minutes or larger), the OS controller 200 (e.g., door controller) can change the operation level of the door fan 180 to a middle or low level to prevent heat generation due to excessive rotation of the door fan 180.

FIG. 14 is a diagram illustrating a process in which the OS controller (e.g., door controller) according to an embodiment of the present disclosure changes an operation level of the door fan based on a cooking time duration.

The OS controller 200 (e.g., door controller) determines that the cooking appliance function provider 560 (e.g., microwave generator, or heat generator) of the function unit 500 (e.g., main over portion) terminates the heating function within a first reference time duration (e.g., 10 seconds, 5 seconds, etc.) in S35. This means that the situation of generating the heat is over (e.g., cooking has finished).

Accordingly, the OS controller 200 (e.g., door controller) lowers the operation level of the door fan in S36. In response to the user increasing the cooking time duration (e.g., adding more cook time) of the cooking appliance function provider 560 of the function unit 500 after lowering the operation level of the door fan 180, the OS controller 200 (e.g., door controller) can increase the operation level of the door fan as lowered in S36 (e.g., the door fan can also be automatically increased based on the increased cook time).

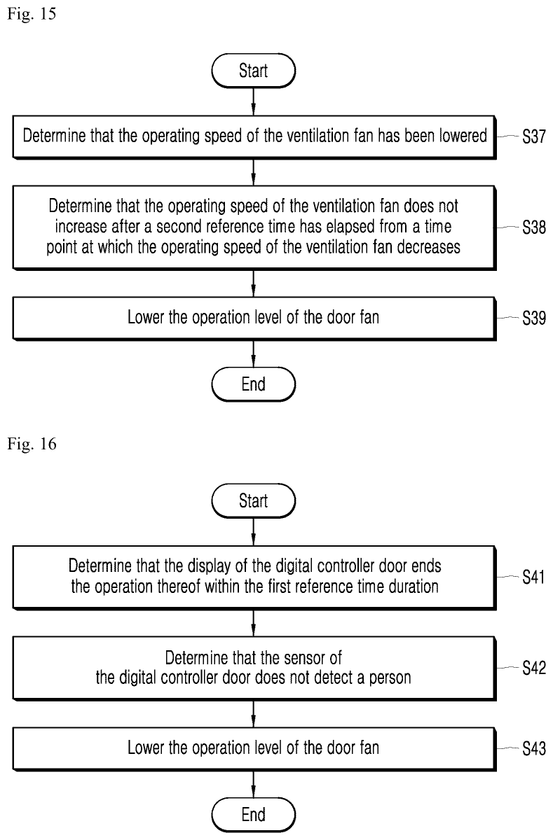

FIG. 15 is a diagram illustrating a process in which the OS controller (e.g., door controller) changes the operation level of the door fan based on an operating time duration of the ventilation fan according to an embodiment of the present disclosure.

The OS controller 200 (e.g., door controller) determines that the operating speed of the ventilation fan 590 of the function unit 500 has been lowered in S37. The OS controller 200 (e.g., door controller) determines that the operating speed of the ventilation fan 590 does not increase after S37, that is, after a second reference time has elapsed from a time point at which the operating speed of the ventilation fan 590 decreases in S38. This corresponds to a state in which heat no longer increases but decreases. Accordingly, the OS controller 200 (e.g., door controller) lowers the operation level of the door fan 180 in S39. For example, if the ventilation fan has been lowered or turned off and remains that way for a predetermined amount of time, then the display door fan can be automatically lowered or turned off as well.

In response to the operating speed of the ventilation fan 590 being increased after the operation level of the door fan 180 has been lowered, the OS controller 200 (e.g., door controller) can increase the operation level of the door fan that has been lowered at S39. For example, if the ventilation fan has been turned on or turned to a higher level, then the display door fan can be automatically turned on or set to a higher level as well.

FIG. 16 is a diagram illustrating a process in which the OS controller (e.g., door controller) changes an operation level of a door fan in relation to an operation of a display according to an embodiment of the present disclosure. In a situation where the operation of the display 160 is expected to end soon, when the OS controller 200 (e.g., door controller) has determined that there is no person in the vicinity, the OS controller 200 can lower the operation level of the door fan.

That is, the OS controller 200 (e.g., door controller) determines that the display of the digital controller door (e.g., display door) ends the operation thereof within the first reference time duration in S41. Then, the OS controller 200 (e.g., door controller) determines that the sensor 140 of the digital controller door 100 does not detect a person in S42. That is, since there is no person therearound, when outputting of the image from the display 160 is terminated, it is determined that there is a high possibility that there is no additional work that the display 160 is to perform. Accordingly, the OS controller 200 (e.g., door controller) automatically lowers the operation level of the door fan 180 in S43.

In response to the sensor 140 detecting a person approaching the cooking appliance after lowering the operation level of the door fan 180, the OS controller 200 (e.g., door controller) can increase the operation level of the door fan 180 which has been lowered in S43.

FIGS. 13 to 16 show an embodiment in which the OS controller 200 (e.g., door controller) changes the operation level of the door fan 180 based on a change in the operation of each component or an expected state in the future even after the operation level of the door fan has been set.

In addition, the embodiment of FIGS. 13 to 16 can include an embodiment of changing the operation level of the door fan 180 after a predetermined time duration has elapsed.

According to one embodiment of the present disclosure, in S36/S39/S43, the OS controller 200 (e.g., door controller) can immediately change the operation level of the door fan 180. In another embodiment, after a predetermined time duration (e.g., 10 seconds, 30 seconds, etc.) has elapsed, the OS controller 200 (e.g., door controller) can perform the S36/S39/S43 process to change the operation level of the door fan 180.

In addition, the OS controller 200 (e.g., door controller) can set the operation level of the door fan based on the error history of each of the components constituting the function unit 500 (e.g., the components of the main oven portion). For example, when the number of times that the ventilation fan 590 or the thermistor 595 has generated an error in the past is N or larger, the OS controller 200 (e.g., door controller) can increase or maintain the operation level of the door fan 180 under a specific condition or set the operating time duration of the door fan 180 to be longer.

For example, even when the rotation speed of the ventilation fan 590 is lowered, the OS controller (e.g., door controller) can maintain the operation level of the door fan 180 without applying the embodiment of FIG. 15.

Similarly, when the number of errors of the thermistor 595 is equal to or greater than a predetermined number of errors, the OS controller 200 (e.g., door controller) can set the operation level of the door fan 180 to be maintained even when the temperature sensed by the thermistor 595 increases and then decreases.

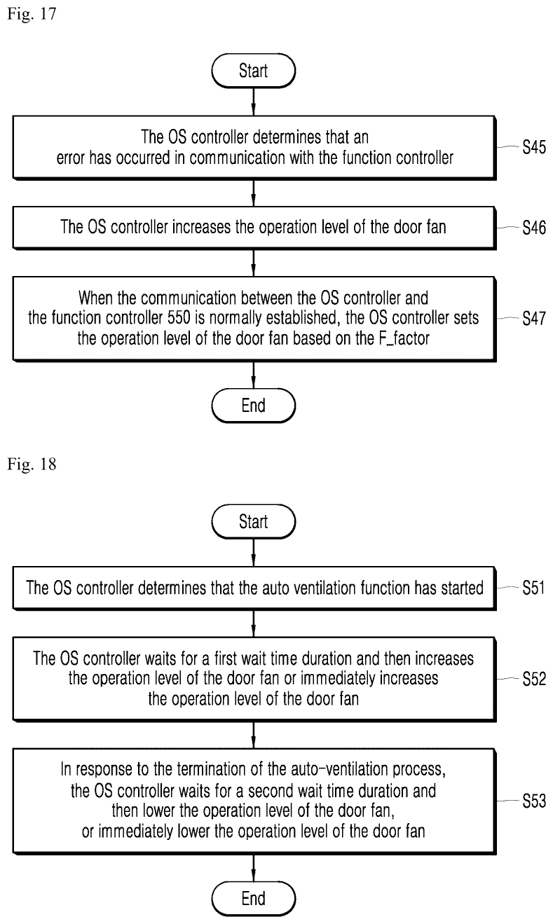

FIG. 17 is a diagram illustrating a process in which an OS controller (e.g., door controller) sets an operation level of a door fan in an error occurrence situation according to an embodiment of the present disclosure.

The OS controller 200 (e.g., door controller) communicates with the function controller 550 (e.g., main controller) periodically or according to a preset scheme. In this process, when the OS controller 200 does not receive the response packet after transmitting the monitoring packet to the function controller 550, the OS controller 200 can determine that an error has occurred in communication with the function controller 550 in S45.

When it is identified that the error has occurred in S45, the OS controller 200 (e.g., door controller) can perform various tasks for restoring the communication with the function controller 550. In this regard, the OS controller 200 (e.g., door controller) may not check the situation occurring in the function unit 500 (e.g., main oven portion).

That is, since the OS controller 200 (e.g., door controller) cannot check the F_factor until the communication with the function controller 550 (e.g., main controller) has been re-established, the OS controller 200 (e.g., door controller) increases the operation level of the door fan 180 for safety in S46 (e.g., which could help cool down components to safe operating levels). Thereafter, when the communication between the OS controller 200 (e.g., door controller) and the function controller 550 (e.g., main controller) is successfully reestablished, the OS controller 200 (e.g., door controller) can set the operation level of the door fan 180 based on the F_factor in S47.

FIG. 18 is a view illustrating a process in which the OS controller (e.g., door controller) sets an operation level of the door fan in the auto ventilation process according to an embodiment of the present disclosure.

When the thermistor 595 detects the temperature, the ventilation fan 590 can automatically operate. This is referred to as an auto ventilation. The function controller 550 (e.g., main controller of the main oven portion) can automatically activate the auto ventilation function based on the temperature sensed by the thermistor 595 to prevent component failure or damage. That is, the function controller 550 (e.g., main controller) can activate the auto-ventilation function when it is determined that the temperature of the thermistor is equal to or higher than a predetermined temperature, and accordingly, can notify the OS controller 200 (e.g., door controller) of information indicating that the auto-ventilation function is being activated.

In response to reception of the notification, the OS controller 200 (e.g., door controller) can display an auto ventilation operation state on the display 160.

The OS controller 200 (e.g., door controller) can display, on the display 160, a pop-up message indicating that the auto ventilation is being activated when the temperature sensed by the thermistor 595 reaches a predetermined temperature condition. This is a function that the user may not cancel or change arbitrarily. Accordingly, the OS controller 200 (e.g., door controller) can display information indicating that the auto ventilation operation is being performed on the display 160 and can also output a message indicating that the auto ventilation operation cannot be changed or cancelled, which can help prevent any user frustration and enhance user convenience. The user may not set a timer for this auto ventilation operation. The ventilation fan 590 is terminated when the auto ventilation has been terminated even though the user turns off the cooking appliance 1000 on the display 160 of the display door.

In addition, the auto-ventilation can be executed when a timer is set. In this situation, the OS controller 200 (e.g., door controller) can display a remaining timer time on the display 160 of the display door when the auto-ventilation operation will be terminated. In addition, when the auto-ventilation operation ends and the timer time ends, the ventilation fan 590 is also turned off.

In one example, when the user starts to operate the ventilation fan 590 during the cooking, an operation intensity of the ventilation fan 590 may not be set to a turbo level (e.g., strong intensity). After the cooking has been finished, the ventilation fan 590 can operate in the turbo level as long as the previously set ventilation fan intensity is the turbo level.

As described above, the auto ventilation function refers to a function provided to protect components of the cooking appliance 1000. Accordingly, when an error occurs in a process in which the function controller 550 (e.g., main controller) cooperates with the OS controller 200 (e.g., door controller), the operations of other components of the functional unit 500 (e.g., main oven portion) can be canceled, but the operation of the ventilation fan 590 executing the auto ventilation can be maintained. Similarly, even when there is no instruction from the OS controller 200 (e.g., door controller), the function controller 550 (e.g., main controller) can automatically start or end the operation of the ventilation fan 590 based on the temperature sensed by the thermistor 595.

The auto ventilation function can be executed even in a state in which the functional unit does not perform a separate cooking function. That is, when a separate cooking function is not performed and if the display 160 is also turned off, the door fan 180 may not operate. Alternatively, the operation level of the door fan 180 can be set to a low speed.

In this situation, the OS controller 200 (e.g., door controller) determines that the auto ventilation function has started in S51. Since heat can be generated in the cooktop 2000, the OS controller 200 (e.g., door controller) waits for a first wait time duration or immediately increases the operation level of the door fan in S52. The first wait time duration can be set based on a time duration for which the display 160 has previously operated, a time duration for which the cooking appliance 1000 has performed a heating function, or a heating intensity.

For example, when the display 160 is continuously turned off or the cooking appliance 1000 does not perform the heating function for a predetermined time duration or greater (for example, 2 hours, etc.) in the past, it is unlikely that heat is generated in the digital controller door 100 (e.g., display door). In this situation, the OS controller 200 (e.g., door controller) sets the first wait time duration to be long (e.g., 3 minutes or more, etc.).

On the contrary, when the display 160 is continuously operating or when the cooking appliance 1000 performs a heating function within a predetermined time duration (e.g., 1 hour) in the past, there is a possibility that heat can be generated in the digital controller door 100 (e.g., display door). In this situation, the OS controller 200 (e.g., door controller) can set the first wait time duration to be short (e.g., 30 seconds, etc.).

The OS controller 200 (e.g., door controller) waits for the above-described first wait time duration and then increases the operation level of the door fan 100 in S52. Alternatively, the OS controller 200 (e.g., door controller) immediately increases the operation level of the door fan 100 in S52.

Thereafter, in response to the termination of the auto-ventilation process, the OS controller 200 (e.g., door controller) can wait for a second wait time duration and then lower the operation level of the door fan, or immediately lower the operation level of the door fan in S53.

In this regard, the second wait time duration can be proportional to the time duration for which the auto-vent is performed. For example, when the auto ventilation has been performed for 10 minutes or longer, the heat generation time duration is highly likely to be long. Thus, the OS controller 200 (e.g., door controller) sets the second wait time duration to be long (e.g., 5 minutes, etc.).

On the other hand, if the auto-ventilation will be finished within 3 minutes, it is highly likely that the heat generation time is short, and thus the OS controller 200 (e.g., door controller) sets the second wait time duration to be short (e.g., 2 minutes, etc.).

As described above, the OS controller 200 (e.g., door controller) waits for the second wait time duration and then lowers the operation level of the door fan 100 in S53. Alternatively, the OS controller 200 (e.g., door controller) immediately lowers the operation level of the door fan 100 in S53.

The above-described embodiments are summarized as follows. The digital controller door 100 (e.g., display door) according to an embodiment of the present disclosure provides a control algorithm for controlling the inside fan of the door of the cooking appliance 1000. The algorithm performed by the OS controller 200 (e.g., door controller) according to the embodiment of the present disclosure includes an algorithm for controlling a fan for cooling of the cooking appliance 1000 and the digital components disposed in the door. The component temperature can be prevented from being excessively high by applying the algorithm.

According to an embodiment, the OS controller 200 (e.g., door controller) of the digital controller door 100 (e.g., display door) including the display 160 such as an LCD or OLED disposed on the door senses the temperature of the cooktop 2000 and determines an operation time point of the ventilation fan 590 (e.g., operation of the microwave oven, etc.). The OS controller 200 of the digital controller door 100 can control the operation of the fan for cooling the heat of the cavity 1011 inside the door and the operation of the door fan (DC fan) 180 for cooling the heat applied to the digital components disposed in the door.

The cooking appliance 1000 according to an embodiment of the present disclosure can control an operation of the ventilation fan 590 coupled to the cooking appliance to block the smoke or heat generated in a separate cooktop (e.g., including an oven or a gas stove) 2000 disposed under the cooking appliance 1000 or to change a flow thereof.

In this situation, the cooking appliance 1000 including the digital controller door 100 (e.g., smart display door) can execute an optimal cooling algorithm in association with an operating condition of the thermistor 595.

That is, when the LCD or OLED (e.g., the display as the screen of the digital controller door) of the cooking appliance 1000 including the digital controller door 100 (e.g., display door) is activated, the door fan 180 for cooling the digital controller door 100 can operate in the LOW state. The door fan 180 operates to maintain the temperature of the basic component of the digital controller door, thereby ensuring that various hardware or software embedded in the digital controller door 100 including the LCD or OLED is properly activated.

In another example, the thermistor 595 disposed at the bottom or the lower end of the cooking appliance 1000 including the digital controller door (e.g., display door) of the present disclosure can sense the temperature of heat generated from the cooktop 2000, and accordingly, the OS controller 200 can automatically increase the operating speed of the door fan 180 or set the same to High. In addition, when the ventilation fan 590 or the microwave oven (MWO) (e.g., cooking appliance function provider) as a cooking appliance operates separately from the temperature of the cooktop 2000, direct heat can occur, and thus the OS controller 200 can set the operation level of the door fan 180 to High.

According to an embodiment of the present disclosure, the OS controller 200 (e.g., door controller) can preferentially consider the thermistor temperature, the on/off state of the LCD or OLED, the operation state of each of the ventilation fan and the microwave oven, and the like in setting the operation condition of the door fan 180. However, the present disclosure is not limited thereto, and in particular, seasonal factors can be applied in response to an increase or decrease in temperature. For example, in the situation of summer, since the overall temperature may be high, the cooking appliance 1000 including the digital controller door 100 can set the reference value of the thermistor temperature to a reference temperature lower than 35 degrees Celsius as shown in Table 1 above.

In addition, the cooking appliance 1000 including the digital controller door 100 can set the operation level to the door fan 180 to various levels. In this situation, the OS controller 200 (e.g., door controller) can also set the range or section of the temperature for operating the door fan 180 to various levels.

An embodiment of the present disclosure in which all the components are combined with each other or operate in combination with each other has been described. However, the present disclosure is not necessarily limited to this embodiment. Within the scope of the purpose of the present disclosure, at least two of all components can be selectively combined with each other or can operate in the selectively combined manner with each other. Furthermore, each of the components can be implemented as an independent hardware. However, some or all of the components can be selectively combined with each other and thus can be implemented using a computer program with a program module to perform some or all of the functions combined in one or more pieces of hardware. The codes and code segments that constitute the computer program can be deduced by a person skilled in the art from the present disclosure. The computer program can be stored in non-transitory computer readable media and read and executed by a computer, thereby implementing the method of the present disclosure. The storage media for storing the computer program can include storage media including magnetic recording media, optical recording media, and semiconductor recording devices. Additionally, the computer program implementing an embodiment of the present disclosure includes a program module transmitted in real time duration through an external device.

Although the embodiments of the present disclosure have been described in more detail with reference to the accompanying drawings, the present disclosure is not necessarily limited to these embodiments, and can be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects. In addition, even though an effect of a configuration of the present disclosure is not explicitly described in describing the embodiment of the present disclosure above, it is obvious that the predictable effect from the configuration should be recognized.

What is claimed is:

1. A cooking appliance, comprising:
a main portion including a cavity for receiving food, and one or more functional components, the main portion being configured to provide a cooking function;
a display door coupled to the main portion, the display door including a display configured to provide a user interface; and
a door controller configured to:
set an operation level of a door fan of the display door based on state information of at least one of the one or more functional components of the main portion or based on state information of at least one component of the display door.

2. The cooking appliance of claim 1, wherein the door controller is further configured to:
receive the state information of the at least one of the one or more functional components of the main portion from a main controller of the main portion, and
set the operation level of the door fan based on a priority of the state information of the at least one of the one or more functional components of the main portion and the state information of the at least one component of the display door.

3. The cooking appliance of claim 1, wherein the door controller is further configured to:
receive a thermistor temperature sensed by a thermistor of the main portion,
in response to the thermistor temperature being equal to or lower than a first reference temperature and the display of the display door being in an off state, set the operation level of the door fan to a first level,
in response to the thermistor temperature being equal to or lower than the first reference temperature and the display of the display door being in an on state, set the operation level of the door fan to a second level higher than the first level, and
in response to the thermistor temperature being greater than the first reference temperature, set the operation level of the door fan to a third level higher than the first level.

4. The cooking appliance of claim 3, wherein the door controller is further configured to:
in response to a ventilation fan of the main portion currently operating or the cooking function currently operating, set the operation level of the door fan to the third level.

5. The cooking appliance of claim 1, wherein the door controller is further configured to:
change the operation level of the door fan based on a first temporal factor of the at least one of the one or more functional components of the main portion or a second temporal factor of the at least one component of the display door.

6. The cooking appliance of claim 5, wherein the door controller is further configured to:
in response to the cooking function currently being executed and having a remaining cook time that will terminate within a first predetermined amount of time, lower the operation level of the door fan.

7. The cooking appliance of claim 5, wherein the door controller is further configured to:
in response to a decrease in an operating speed of a ventilation fan of the main portion and an amount of time from a start of the decrease being greater than a predetermined amount of time, lower the operation level of the door fan.

8. The cooking appliance of claim 5, wherein the door controller is further configured to:
in response to a display operation of the display ending within a first predetermined amount of time, lower the operation level of the door fan.

9. The cooking appliance of claim 1, wherein the door controller is further configured to:
set the operation level of the door fan based on an error history of the at least one of the one or more functional components of the main portion.

10. The cooking appliance of claim 1, wherein the door controller is further configured to:
in response to a communication error occurring between the door controller and a main controller of the main portion, increase the operation level of the door fan.

11. A method of controlling a cooking appliance, the method comprising:
displaying a user interface by a display of a display door that is coupled to a main portion of the cooking appliance, the main portion including a cavity for receiving food and one or more functional components; and
setting, by a door controller of the display door, an operation level of a door fan of the display door based on state information of at least one of the one or more functional components of the main portion or based on state information of at least one component of the display door.

12. The method of claim 11, further comprising:
receiving, by the door controller, the state information of the at least one of the one or more functional components of the main portion from a main controller of the main portion; and
setting, by the door controller, the operation level of the door fan based on a priority of the state information of the at least one of the one or more functional components of the main portion and the state information of the at least one component of the display door.

13. The method of claim 11, further comprising:
receiving, by the door controller, a thermistor temperature sensed by a thermistor of the main portion;
in response to the thermistor temperature being equal to or lower than a first reference temperature and the display of the display door being in an off state, setting the operation level of the door fan to a first level;
in response to the thermistor temperature being equal to or lower than the first reference temperature and the display of the display door being in an on state, setting the operation level of the door fan to a second level higher than the first level; and
in response to the thermistor temperature being greater than the first reference temperature, setting the operation level of the door fan to a third level higher than the first level.

14. The method of claim 13, further comprising:
in response to a ventilation fan of the main portion currently operating or a cooking function currently operating, setting the operation level of the door fan to the third level.

15. The method of claim 11, further comprising:
changing the operation level of the door fan based on a first temporal factor of the at least one of the one or more functional components of the main portion or a second temporal factor of the at least one component of the display door.

16. The method of claim 15, further comprising:
in response to a cooking function currently being executed and having a remaining cook time that will terminate within a first predetermined amount of time, lowering the operation level of the door fan.

17. The method of claim 15, further comprising:
in response to a decrease in an operating speed of a ventilation fan of the main portion and an amount of time from a start of the decrease being greater than a predetermined amount of time, lowering the operation level of the door fan.

18. The method of claim 15, further comprising:
in response to a display operation of the display ending within a first predetermined amount of time, lowering the operation level of the door fan.

19. The method of claim 11, further comprising:
setting the operation level of the door fan based on an error history of the at least one of the one or more functional components of the main portion.

20. The method of claim 11, further comprising:
in response to a communication error occurring between the door controller and a main controller of the main portion, increasing the operation level of the door fan.
